(19) United States
(12) Patent Application Publication
(10) Pub. No.: US 2008/0241616 A1
(43) Pub. Date: Oct. 2, 2008

(54) FUEL CELL SYSTEM

(75) Inventors: Akihiko Ono, Tokyo (JP); Hideo Kitamura, Yokohama-shi (JP); Yoshiyuki Isozaki, Tokyo (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/050,108

(22) Filed: Mar. 17, 2008

(30) Foreign Application Priority Data
Mar. 28, 2007 (JP) 2007-084286

(51) Int. Cl. H01M 8/06; H01M 8/04

(52) U.S. Cl. 429/20; 429/24

(57) ABSTRACT

A fuel cell system includes a fuel supplier supplying hydrocarbon-based fuel, a water supplier supplying water, an oxygen supplier supplying oxygen-containing gas for combustion, a combustion vessel connected to the fuel supplier, the water supplier and the oxygen supplier, and containing a catalyst to accelerate combustion reaction of the fuel and oxygen, a reformer connected to the combustion vessel and serving to react the fuel with water to convert them into a hydrogen-containing gas, a fuel cell disposed to enable heat transfer with the combustion vessel and generating power by electrochemical reaction between the hydrogen-containing gas supplied from the reformer and an oxygen-containing gas for power generation, and a controller controlling flow rates of the fuel, the water and the oxygen-containing gas for combustion supplied to the combustion vessel by controlling the fuel supplier, the water supplier and the oxygen supplier.

### CROSS-REFERENCE TO RELATED APPLICATIONS

This application is based upon and claims the benefit of priority from prior Japanese Patent Application No. 2007-084286, filed Mar. 28, 2007, the entire contents of which are incorporated herein by reference.

### BACKGROUND OF THE INVENTION

1. Field of the Invention

The present invention relates to a fuel cell system.

2. Description of the Related Art

Electronic devices such as personal computers and portable phones have been greatly miniaturized in recent years, and fuel cells have been attempted to be used as power sources along with the miniaturization of these electronic devices. Since the fuel cell has advantages for power generation merely by supplying a fuel and an oxidant, and the possibility of continuous power generation merely by replenishing the fuel, the fuel cell is quite effective as a power source of miniaturized electronic devices. Proposed fuel cells include direct methanol fuel cells that generate power by directly supplying methanol to an anode, and fuel-reforming fuel cells that generate power by supplying hydrogen gas to an anode of the fuel cell having a solid polymer electrolyte membrane after reforming an organic fuel into hydrogen gas with a reformer.

In the reforming fuel cell, a gas (reformed gas) obtained by reforming alcohols or dimethyl ether contains carbon dioxide and about 1% of carbon monoxide as by-products besides hydrogen. Carbon monoxide (CO) degrades an anode catalyst in a fuel cell stack to cause a decrease in power generation performance. Accordingly, there has been developed a fuel cell system in which, when a hydrogen-containing gas is supplied from a reformer to the fuel cell, the concentration of carbon monoxide is reduced by converting carbon monoxide into carbon dioxide using a CO shift converter or by converting carbon monoxide into carbon dioxide or methane using a selective CO oxidizer or CO methanizer.

The fuel cell has low power generation ability due to low activity of the catalyst on an electrolyte membrane at the starting of the fuel cell or in a cold-start state where the cell is in lower temperatures. On the contrary, it is known that a high power generation performance can be maintained when the fuel cell is kept at high temperatures for power generation since both catalyst activity and CO resistance are high. Since a so-called mid-temperature fuel cell using a polymer electrolyte membrane represented by a phosphate-doped polybenzimidazole membrane has quite high CO resistance, it is possible to generate power by directly introducing a reformed gas that contains about 1% of carbon monoxide into the fuel cell. However, the CO resistance is high only when the temperature of the fuel cell is high. In addition, the phosphate-doped polybenzimidazole membrane involves a problem that phosphoric acid is eluted when water is condensed, and thus it is necessary to raise the temperature high enough to prevent water from being condensed during operation.

A fuel cell system in which the fuel cell is heated at the starting or in a cold-start state has been proposed. For example, JP-A 7-94202 (KOKAI) discloses a fuel cell system that performs warming-up at the start of the cell by providing heater in a passage for supplying cooling water to the fuel cell. JP-A 2004-281074 (KOKAI) discloses a fuel cell system capable of both heating and cooling by providing a cooling water passage and catalytic combustion passage within the fuel cell.

However, the system disclosed in JP-A 7-94202 (KOKAI) involves a problem that a battery for driving a heater and an accompanying electric circuit are necessary since the fuel cell is warmed up by the heater heating circulating water. The battery and accompanying electric circuit are not needed in the structure in which the fuel cell is warmed by combustion in place of the heater. However, since the circulating water passage has a dead volume, a large amount of energy is lost due to heating the entire volume of circulating water in the dead volume when the fuel cell is warmed up. Furthermore, complicated control of many units such as a circulation pump, radiator and heater for warming-up and cooling of the fuel cell with circulating water may interfere with miniaturization and simplification of the fuel cell.

The system disclosed in JP-A 2004-281074 (KOKAI) may involve the same problem as in the system disclosed in JP-A 7-94202 (KOKAI) since both systems use the circulating water passage. If the cooling water circulation passage is integrated with the combustion passage, it may be possible to flow circulating water when the fuel cell is cooled and to subject the catalyst to a combustion reaction in the passage when the fuel cell is heated, depending on the temperature situation of the fuel cell stack. However, this system also becomes complicated since valves and valve actuating circuits are necessary for switching two passages.

### BRIEF SUMMARY OF THE INVENTION

According to an aspect of the present invention, there is provided a fuel cell system comprising: a fuel supplier supplying a hydrocarbon-based fuel; a water supplier supplying water; an oxygen supplier supplying an oxygen-containing gas for combustion; a combustion vessel connected to the fuel supplier, the water supplier and the oxygen supplier, and containing a catalyst to accelerate combustion reaction of the fuel and oxygen; a reformer connected to the combustion vessel and serving to react the fuel with water to convert them into a hydrogen-containing gas; a fuel cell disposed to enable heat transfer with the combustion vessel and generating power by electrochemical reaction between the hydrogen-containing gas supplied from the reformer and an oxygen-containing gas for power generation; and a controller controlling flow rates of the fuel, the water and the oxygen-containing gas for combustion supplied to the combustion vessel by controlling the fuel supplier, the water supplier and the oxygen supplier.

### BRIEF DESCRIPTION OF THE SEVERAL VIEWS OF THE DRAWING

FIG. 1 is a diagram showing a structure of a fuel cell system according to a first embodiment;

FIG. 2 is a perspective view showing the structure of a fuel vessel;

FIG. 3 is a diagram showing a structure of a fuel cell system according to a second embodiment;

FIG. 4 is a diagram showing a structure of a fuel cell system according to a third embodiment;

FIG. 5 is a diagram showing a structure of a fuel cell system according to a fourth embodiment;

FIG. 6 is a diagram showing a structure of a fuel cell system according to a fifth embodiment; and

FIG. 7 is a diagram showing a structure of a heat exchanger.

### DETAILED DESCRIPTION OF THE INVENTION

Embodiments of the invention will be described hereinafter with reference to the drawings.

### First Embodiment

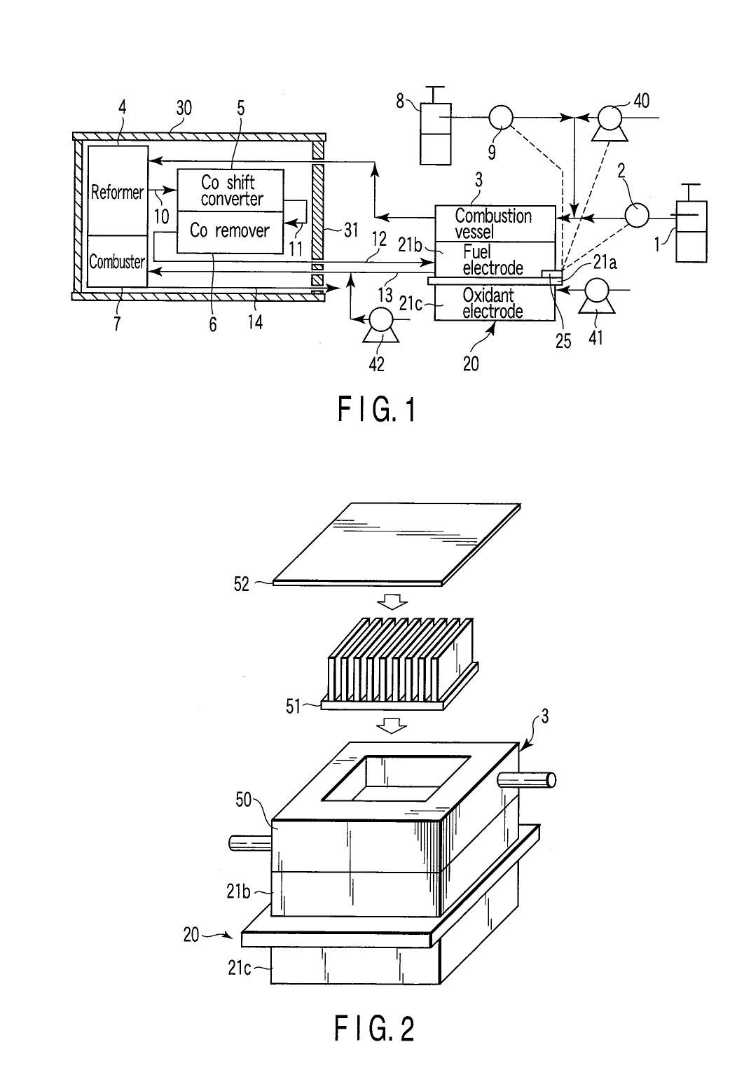

FIG. 1 shows a structure of a fuel cell system according to a first embodiment. An outline of this fuel cell system will be given below.

A fuel cell 20 includes a polymer electrolyte membrane 21a, a fuel electrode (anode electrode) 21b formed on one surface of the polymer electrolyte membrane 21a, and an oxidant electrode 21c (cathode electrode) formed on the other surface of the polymer electrolyte membrane 21a. The fuel cell 20 generates power by an exothermic electrochemical reaction between an oxygen-containing gas and a hydrogen-containing gas.

A fuel of an organic compound containing carbon and hydrogen is contained in a fuel vessel 1. The fuel is supplied to a combustion vessel 3 from the fuel vessel 1 through a flow controller 2 serving as a fuel supplier. Water is contained in a water vessel 8. Water is supplied to the combustion vessel 3 from the water vessel 8 through another flow controller 9 serving as a water supplier. An oxygen-containing gas for combustion (or air) is supplied to the combustion vessel 3 through a first oxygen supplier (i.e., air supply fan) 40. A catalyst for accelerating combustion reaction between the fuel and oxygen is contained in the combustion vessel 3. The fuel cell 20 is disposed adjacent to the combustion vessel 3 so as to enable heat transfer.

The fuel and water supplied to a reformer 4 through the combustion vessel 3 are converted into a hydrogen-containing gas. The hydrogen-containing gas generated in the reformer 4 is sent to a CO shift converter 5 to reduce the CO content, and CO is removed by sending the gas into a CO remover 6. The hydrogen-containing gas, the CO content of which has been reduced, is introduced into the fuel electrode 21b of the fuel cell 20, while air as an oxygen-containing gas for power generation is introduced into the oxidant electrode 21c of the fuel cell 20 with a second oxygen supplier (i.e., air supply fan) 41, and thus power is generated. A waste gas containing unreacted hydrogen gas from the fuel electrode 21b is sent to a combustor 7 together with the air from a third oxygen supplier (i.e., air supply fan) 42. The reformer 4 is heated by the combustion reaction in the combustor 7. A temperature detector 25 is provided at the fuel cell 20. The temperature detector 25 serves as a controller for controlling the fuel flow controller 2, the flow controller 9 of water and the first oxygen supplier (i.e., air supply fan) 40 depending on the temperature of the fuel cell 20.

Details of the fuel cell system according to the first embodiment will be described below.

Pressure vessels may be used as the fuel vessel 1 and water vessel 8. The fuel vessel 1 and water vessel 8 are preferably made of a transparent material such as resin in order to confirm the volume in the vessel by visual inspection.

The fuel vessel 1 contains dimethyl ether (DME), butane, liquefied natural gas (LNG) or methanol as a fuel of an organic compound containing carbon and hydrogen. For example, dimethyl ether (DME) has a saturated vapor pressure higher than atmospheric pressure, and has a pressure of about 6 atm at an normal temperature. A controllable flow controller 2 controlling the flow rate of the fuel gas is connected to the fuel vessel 1. The pressurized fuel gas flows out of the fuel vessel 1 at a given flow rate by controlling the flow controller 2, and is supplied to the combustion vessel 3 through a pipe. The water vessel 8 contains water. The water vessel 8 is provided with a controllable flow controller 9 controlling the flow rate of water. Water flows out of the water vessel 8 at a given flow rate by controlling the flow controller 9, and is supplied to the combustion vessel 3 through a pipe. The oxygen-containing gas for combustion (or air) is supplied to the combustion vessel 3 at a given flow rate by controlling the first oxygen supplier (i.e., air supply fan) 40.

FIG. 2 is a perspective view showing the structure of the combustion vessel 3. The combustion vessel 3 comprises a vessel body 50 mounted in contact with the wall surface of the fuel electrode 21b of the fuel cell 20, a channel structure 51 fitted to the vessel body 50 to form micro-channel passages, and a cover 52. The cover 52 is welded by TIG welding or laser welding so as to seal the vessel body 50. The pipes supplying the fuel, water and air, and a pipe to the reformer 4 are connected to the vessel body 50. The term “micro-channel” means a structure that a pitch between the channels is less than 1 mm.

Providing the vessel body 50 of the combustion vessel 3 in contact with the wall surface of the fuel cell 20 (fuel electrode 21b) allows heat transfer between the fuel cell 20 and combustion vessel 3. The shape and arrangement of the combustion vessel 3 are not particularly limited as long as heat transfer is possible between the combustion vessel and fuel cell 20.

While the wall surface of the channel structure 51 in FIG. 2 forms parallel passages having trenches perpendicular to the bottom surface of the vessel body 50, the structure of the wall surface of the channel structure 51 is arbitrary, and may form serpentine passages. The channel structure 51 may be produced by wire machining when the channel structure 51 has a configuration of linear passages. A combustion catalyst is provided on the wall surface of the channel structure 51.

Examples of the combustion catalyst include a platinum-alumina catalyst (Pt/Al₂O₃) and a palladium-alumina catalyst (Pd/Al₂O₃) when methanol is used as the fuel. These combustion catalysts accelerate the reaction for forming water and carbon dioxide by combustion of methanol with oxygen as shown in formula (1):

CH₃OH+O₂→2H₂O+CO₂ (1)

Temperature control of the fuel cell 20 by the combustion vessel 3 will be outlined below.

As described above, it is necessary for the temperature of the fuel cell to be substantially high, in order to obtain high catalyst activity and high CO resistance, and if necessary, for preventing phosphoric acid from being eluted by the condensed water. Accordingly, the combustion reaction is made to occur by introducing only the fuel and air into the combustion vessel 3 when the temperature of the fuel cell 20 is lower than an optimal operation temperature, such as at the starting of the fuel cell operation. The heat of combustion is thus transferred to the fuel cell 20 adjacent to the combustion vessel 3, and the temperature of the fuel cell 20 is rapidly increased to enable prompt start-up of the cell. Since no electric heater is used for start-up of the fuel cell 20 by heating, an electric circuit for controlling electric energy of the electric heater and action of the heater is not needed in this embodiment.

The fuel cell 20 generates heat with power generation during stationary power generation. The stationary power generation state means a state that a difference in quantity of heat, determined by subtracting the quantity of heat dissipated from the fuel cell from the quantity of heat generated by the fuel cell, balances with the quantity of heat of vaporization of water. Here, the expression “the difference in quantity of heat balances with the quantity of heat of vaporization of water” means that the difference in quantity of heat is five percent or less of the designed quantity of heat generated by the fuel cell. In this case, only the fuel and water are supplied to the combustion vessel 3, the fuel and water are vaporized by the heat generated by the fuel cell 20, and the temperature of the fuel cell 20 is maintained in a predetermined range by cooling the fuel cell 20 with the heat of evaporation. The fuel cell is cooled with other cooling units such as a cooling fan when the temperature of the fuel cell 20 exceeds the predetermined range even by using the heat of evaporation of the fuel and water.

The temperature of the fuel cell 20 is finely controlled during suppression of power generation. In the suppressed power generation, the quantity of heat generated by the fuel cell becomes lower than the total quantity of heat of vaporization of the fuel and water. For example, when the output power generated by the fuel cell 20 is small, or when no output is generated by the fuel cell 20 and only the energy for activating the fuel cell system is supplied by the fuel cell 20, the amount of heat generated at the fuel cell 20 reduces since power generation is suppressed, which causes lowering in the temperature of the fuel cell 20. When this operation is continued, the temperature of the fuel cell 20 is lowered below the predetermined range, thus making it difficult to obtain output from the fuel cell 20. In this case, even when the temperature of the fuel cell 20 is within the predetermined range, a part of the fuel is burnt by supplying the fuel, water and air to the combustion vessel 3 in order to maintain or increase the temperature of the fuel cell 20.

The control as described above will be described by introducing the variables below:

Qout: the quantity of heat dissipated from the fuel cell 20 to the outside by natural convection;

Qpower: the quantity of heat generated by power generation of the fuel cell 20;

Qin: the quantity of heat in the combustion vessel 3;

Qcomb: the quantity of heat of combustion in the combustion vessel 3; and

Qvap: the quantity of heat of vaporization of the fuel and water in the combustion vessel 3,

where Qin=Qcomb+Qvap.

The quantity of heat is controlled as follows for maintaining the fuel cell 20 within a predetermined temperature range:

when the temperature of the fuel cell 20 is to be lowered; Qout<Qpower+Qin, and

when the temperature of the fuel cell 20 is to be raised; Qout>Qpower+Qin.

For satisfying the above conditions, it may be conceived to control the flow rate of air among the air, water and fuel supplied to the combustion vessel 3. For example, the quantity of heat Qcomb by combustion, and thus Qin, may be increased by increasing the amount of air. On the contrary, the quantity of heat Qcomb by combustion, and thus Qin, may be decreased by decreasing the amount of air. By such control, it is possible to maintain the temperature of the fuel cell 20 within a predetermined range while the fuel cell 20 is operated under stationary conditions, enabling a prompt response to the demand of output from the fuel cell 20 to the outside.

Temperature control of the fuel cell 20 by the combustion vessel 3 will be described in more detail with reference to specific examples. The fuel cell 20 with an output of about 50 W having a phosphate-doped polybenzimidazole membrane, which operates through the reformation of methanol, will be described hereinafter as an example.

The quantity of heat dissipated, Qout, from the fuel cell 20 to the outside by natural convection is estimated to be 24.6 W, based on the size of the fuel cell stack and the surface temperature of the heat insulator.

Methanol (250 cc/min) and water (312.5 cc/min) are supplied to the combustion vessel 3 and vaporized to obtain an output of 50 W. The quantity of heat of vaporization, Qvap, is about −19.3 W. Since air is not supplied to the combustion vessel 3, the heat of combustion, Qcomb, is zero. On the other hand, the quantity of heat, Qpower, obtained by power generation at 50 W is about 44.8 W. The relation between Qout and Qpower+Qin is as follows:

Qout(24.6 W)<Qpower(44.8 W)+Qin(−19.3 W)=25.5 W.

Since the quantity of heat dissipation of the fuel cell 20 may be considered to be approximately equal to the quantity of heat generation of the fuel cell 20, although the former is about 0.9 W larger than the latter, the temperature of the fuel cell 20 may be maintained approximately within the predetermined range. However, since the temperature of the fuel cell 20 may happen to exceed the predetermined range due to a temperature rise, a cooling system such as a cooling fan is preferably provided.

Next, suppose that the output is suppressed to 30 W under the same amount of fuel supplied. The quantity of heat dissipation, Qout, of the fuel cell 20 is estimated as 24.6 W, as described above. The quantity of heat generation, Qpower, as a result of power generation at the output of 30 W is about 15.9 W. The quantity of heat Qvap by vaporization is about −19.3 W as described above. The relation between Qout and Qpower+Qin is as follows:

Qout(24.6 W)>Qpower(15.9 W)+Qin(−19.3 W)=−3.4 W.

Since the quantity of heat generation of the fuel cell 20 is substantially smaller than the quantity of heat dissipation Qout of the fuel cell 20, the temperature of the fuel cell 20 continuously decreases.

Accordingly, the temperature of the fuel cell 20 is made to increase with use of the quantity of heat of combustion by burning a part of the fuel by supplying air. For example, suppose that additional air is supplied at a rate of 350 cc/min under the same supply amount of the fuel in order to obtain an output of 30 W. The quantity of heat dissipation Qout of the fuel cell 20 is estimated to be 24.6 W as described above. The quantity of heat generation Qpower accompanied by power generation at the output power of 30 W is about 20.4 W under the conditions. The quantity of heat generation accompanied by power generation may be different depending on the efficiency of use of hydrogen even at the same output power of 30 W. The quantity of heat of vaporization Qvap is −20.4 W under the conditions. The quantity of heat may be different by consumption of energy for heating air when air is present, even when the flow rate of the fuel is the same. The quantity of heat of combustion Qcomb in the combustion vessel 3 is about 24.6 W. The relation between Qout and Qpower+Qin (=Qcomb+Qvap) is as follows:

$$\begin{matrix}Qout ( 24.6 W ) = Qpower ( 20.4 W ) + Qin ( 24.6 W - 20.4 W ) \\ = 24.6 W\end{matrix}$$

Since the quantity of heat dissipation Qout of the fuel cell 20 is equal to the quantity of heat generation of the fuel cell 20 in this case, the temperature of the fuel cell 20 is maintained.

The temperature of the fuel cell 20 is lowered when the flow rate of air is decreased, since Qcomb (and thus Qin) decreases. On the contrary, the temperature of the fuel cell 20 is raised when the flow rate of air is increasee, since Qcomb (and thus Qin) increases.

Next, suppose that the supply amount of the fuel is decreased to suppress the output to 20 W. For example, methanol (150 cc/min) and water (187.5 cc/min) as well as air (300 cc/min) are supplied to the combustion vessel 3 in order to burn a part of the fuel. Under these conditions, the quantity of heat of vaporization Qvap of the fuel and water is about −12.5 W while the quantity of heat of combustion Qcomb is about 21.1 W. On the other hand, the quantity of heat generation Qpower by power generation at the output of 20 W is about 15.9 W. The relation between Qout and Qpower+Qin (=Qcomb+Qvap) is as follows:

Qout(24.6 W)>Qpower(15.9 W)+Qin(21.1 W−12.5 W)=24.5 W

Since the quantity of heat generation of the fuel cell 20 is about 0.1 W larger than but approximately equal to the quantity of heat dissipation Qout of the fuel cell 20, the temperature of the fuel cell 20 may be maintained within the predetermined range.

The reformer 4 in a vacuum heat-insulation vessel 30 will now be described. The reformer 4 is connected to the combustion vessel 3 via a pipe. The fuel and water vaporized in the combustion vessel 3 are introduced into the reformer 4 through the pipe, and are converted into a hydrogen-containing gas, that is a reformed gas. Passages of a serpentine type or parallel type through which the vaporized fuel passes are provided in the reformer 4. A reforming catalyst for accelerating the reforming reaction of the fuel is provided on the wall surface of the passage.

A mixture of Pd/ZnO and γ-alumina or a platinum-alumina (Pt/Al₂O₃) catalyst may be used as the reforming catalyst when the fuel contains dimethylether. The reforming catalyst accelerates a steam reforming reaction of dimethylether as shown in the formula (2). The platinum-alumina catalyst preferably has an amount of supported Pt between 0.25 wt % or more and 1.0 wt % or less.

CH₃OCH₃+3H₂O→6H₂+2CO₂ (2)

It seems desirable that the ratio of the flow rate (or molar ratio) of dimethylether to water is 1:3 in terms of stoichiometry. However, a large amount of carbon monoxide is produced when the flow rate ratio is close to 1:3 in an actual fuel cell system. On the other hand, excess water may be used for the shift conversion reaction and power generation, as will be described later. Accordingly, the ratio of the flow rate of dimethylether to water is preferably adjusted to be 1:3.5 or more. However, since the energy required for heating and vaporization of the fuel increases when the flow rate of water is too large, the mixing ratio of dimethylether to water is preferably 1:5.0 or less, more preferably 1:4.0 or less.

A reforming catalyst such as Cu/ZnO/γ-alumina, Pd/ZnO or platinum-alumina (Pt/Al₂O₃) may be used when methanol is used as the fuel. Such reforming catalyst accelerates a steam reforming reaction of methanol shown in the formula (3):

CH₃OH+H₂O→3H₂+CO₂ (3)

While a ratio of the flow rate (molar ratio) of methanol to water of 1:1 seems to be desirable in this reaction in terms of stoichiometry, this mixing ratio is preferably 1:5.0 or less, more preferably 1:4.0 or less for the same reason as for dimethylether.

If a high corrosion resistance is required for the reformer 4, it is effective to use noble metals. Further, the temperature range within which the reforming catalyst operates most efficiently is from 200 to 400° C. Accordingly, the temperature of the reformer 4 is preferably controlled so that the surface temperature of the reforming catalyst is in the range of 200 to 400° C.

The structure of the reformer 4 will be described below. At least a part of the reaction vessel constituting the reformer 4 is desirably formed of a material having high heat conductivity. This is because the heat of combustion generated in the combustor 7 is allowed to be efficiently transferred to the reformer 4. Examples of materials having a high heat conductivity are aluminum, copper, aluminum alloys and copper alloys. A stainless steel alloy having excellent corrosion resistance may also be used, although the heat conductivity of stainless steel alloys is lower than that of aluminum, copper, aluminum alloys and copper alloys. The reaction vessel may be formed using a conventionally used machining method or molding method. Examples of the machining method available include electric discharging and milling. Examples of the molding method include forging and casting. For example, the machining method and molding method may be combined for use such that a reaction vessel having no inlet pipe or outlet pipe is molded by casting, and pipe members are welded to the through hole portions after providing through holes by a machining method such as drilling.

While the method for producing the reformer 4 has been described as an example, descriptions of the structures of the CO shift converter 5, CO remover 6 and combustor 7 are omitted herein since their overall structures are the same as that of the reformer 4, although the width and length of the passage differ depending on the kind of catalyst and reaction rate.

The CO shift converter 5 may be provided in the reformer 4. The CO shift converter 5 will be described below. The CO shift converter 5 is connected to the reformer 4 via a feed passage 10. The reformed gas from the reformer 4 contains hydrogen as well as carbon dioxide and carbon monoxide as by-products. Carbon monoxide causes the anode catalyst of the fuel cell to be deteriorated, which decreases the power generation performance of the fuel cell system. Accordingly, carbon monoxide is shift-converted into carbon dioxide and hydrogen in the CO shift converter 5 in order to decrease the concentration of CO while the amount of hydrogen generated is increased. A passage for allowing the reformed gas to pass is provided in the CO shift converter 5, and a shift conversion catalyst for accelerating the shift conversion reaction of carbon monoxide contained in the reformed gas is provided on the wall surface of the passage. The passage through which the reformed gas passes in the CO shift converter 5 is a serpentine type or a parallel type as in the reformer 4. The shift conversion catalyst provided on the wall surface of the passage accelerates the shift conversion reaction shown in the formula (4):

CO+H₂O→H₂+CO₂ (4)

A solid base supporting a noble metal including Pt is used for the shift conversion catalyst. Either Pd or Ru may be used in place of Pt. Alumina supporting Ce or Re is used as the solid base, although alumina supporting any of K, Mg, Ca and La may be used in place of the alumina supporting Ce or Re. A known Cu/ZnO catalyst may be used in addition to the CO shift conversion catalyst. The catalyst supporting a noble metal containing Pt, Pd or Ru is preferably used when corrosion resistance of the CO shift converter 5 is to be improved. The temperature range within which the shift conversion catalyst operates most efficiently is between 200 and 400° C. Accordingly, the temperature of the CO shift converter 5 is preferably controlled so that the surface temperature of the shift conversion catalyst is in the range of 200 to 300° C.

The CO remover 6 may be provided downstream of the CO shift converter 5. The CO remover 6 will be described in detail below. The CO remover 6 is connected to the CO shift converter 5 via the feed passage 11. While carbon monoxide is subjected to a shift conversion reaction in the CO shift converter 5, the reformed gas sent to the CO remover 6 still contains about 1 to 2% of carbon monoxide. CO causes a decrease in power generation performance of the fuel cell system, as described above. Accordingly, carbon monoxide is removed in the CO remover 6 so that the carbon monoxide concentration is reduced to 100 ppm or less before the gas containing hydrogen is supplied to the fuel cell 20. A passage through which the reformed gas passes is provided within the CO remover 6, and a methanation catalyst for accelerating the methanation reaction of carbon monoxide is provided, for example, on the wall surface of the passage. The passage through which the reformed gas passes in the remover 6 is a serpentine type or a parallel type, as in the reformer 4 or CO shift converter 5. The methanation catalyst provided on the wall surface of the passage accelerates the methanation reaction, as shown in the formula (5):

CO+3H₂→CH₄+H₂O (5)

Ru/Al₂O₃ or Ru/zeolite, or a catalyst having Ru/Al₂O₃ or Ru/zeolite as a main component and supporting at least one element selected from Mg, Ca, K, La, Ce and Re is preferably used as the methanation catalyst.

The heat insulation vessel 30 will be described below. The heat insulation vessel 30 is formed into a flat shape, and includes an inner wall surrounding a vacuum hollow portion and an outer wall, and has an opening on one surface. The above-mentioned members are housed within the heat insulation vessel 30, and a heat insulating member 31 is provided at the opening. The heat insulation member 31 is formed, for example, of mineral wool, ceramic fiber, calcium silicate, a vacuum heat insulation material (for example Al layers are laminated on both surfaces of a ceramic fiber layer or calcium silicate layer), foamed urethane, tile, hard urethane foam, or a non-sealed cell structure of an inorganic fiber-reinforced ceramic powder with a size of 0.1 μm or less (for example MICROTHERM™ manufactured by Nippon Microtherm Co., Ltd). Sufficient heat resistance at a temperature of as high as 150° C. may be obtained by using the non-sealed cell structure of an inorganic fiber-reinforced ceramic powder with a size of 0.1 μm or less. The shape of the heat insulation vessel 30 is not limited to flat, and may be square or cylindrical.

The fuel cell 20 will be described below. The fuel cell 20 includes a polymer electrolyte membrane 21a, a fuel electrode (or anode electrode) 21b formed on one surface of the polymer electrolyte membrane 21a, and an oxidant electrode 21c (or cathode electrode) formed on the other surface of the polymer electrolyte membrane 21a. The fuel electrode 21b of the fuel cell 20 is connected to the CO remover 6 via a reformed gas outlet tube 12 that penetrates the heat insulation member 31. The fuel cell 20 generates power by allowing hydrogen in the reformed gas to react with oxygen in air. The second oxygen supplier (i.e., air supply fan) 41 for sending air to the oxidant electrode (or cathode electrode) 21c is connected to the fuel cell 20.

A membrane having proton conductivity, such as a fluorocarbon polymer having a cation exchange group such as sulfonic acid group or carboxylic acid group, for example Nafion (trade name of DuPont), is used as the polymer electrolyte membrane 21a. Another polymer electrolyte membrane 21a available is a polybenzimidazole porous membrane (PBI) doped with phosphoric acid. A porous sheet in which a carbon black powder supporting Pt, for example, is retained with a water-repellent resin binder such as polytetrafluoroethylene (PTFE) may be used as the fuel electrode 21b and oxidant electrode 21c. The porous sheet may contain a sulfonic acid-type perfluorocarbon polymer or fine particles coated with the polymer.

Hydrogen supplied to the fuel electrode 21b is subjected to a reaction shown in the formula (6) below:

H₂→2H+e⁻ (6)

Oxygen supplied to the oxidant electrode is subjected to a reaction shown in the formula (7):

½O₂+2H⁺+2e⁻→H₂O (7)

The combustor 7 will be described below. The combustor 7 is provided for heating the reformer 4. The combustor 7 is connected to the fuel electrode of the fuel cell 20 via an inlet tube 13 that penetrates the heat insulation member 31. An exhaust gas (or anode-off gas) discharged from the fuel electrode of the fuel cell 20 is supplied to the combustor 7. While water is generated at the fuel cell 20 by a reaction between hydrogen and oxygen, the exhaust gas contains unreacted residual hydrogen. The combustor 7 burns unreacted residual hydrogen using the oxygen in the air, and heats the reformer 4, CO shift converter 5 and CO remover 6 by taking advantage of the heat of combustion generated. The reformer 4, CO shift converter 5, CO remover 6 and combustor 7 are housed in the vacuum heat insulation vessel 30 in order to increase the heating efficiency, homogenize the temperature and protect parts with low heat resistance (such as electronic circuits). An exhaust pipe 14 for discharging the combustion gas to the outside is connected to the combustor 7, and exits to the outside through the heat insulation member 31.

Passages of a serpentine type or parallel type are provided in the combustor 7. A combustion catalyst such as alumina supporting a noble metal such as Pt or Pd, or both, is provided on the wall surface of the passage. The noble metal is used for the combustion catalyst in order to prevent the combustion catalyst from being oxidized or deteriorated without adding any attached devices when the fuel cell is shut down. The combustor 7 may be provided with a heater. Examples of the heater include those prepared by bonding a ceramic heater on an aluminum plate or those prepared by embedding a rod heater in the aluminum plate.

### Second Embodiment

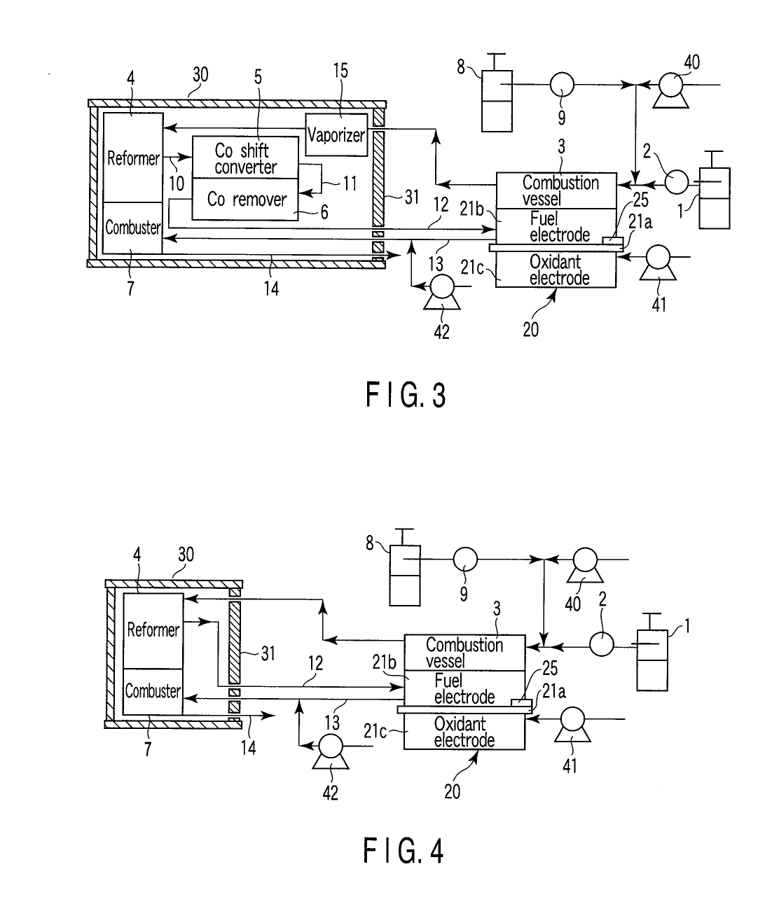

FIG. 3 is a diagram of a fuel cell system according to a second embodiment. The structure of the fuel cell system according to the second embodiment that differs from the structure of the fuel cell system according to the first embodiment will be mainly described below.

When the temperature of the fuel cell 20 is lower than a predetermined range such as at the starting of the fuel cell 20, only the fuel and air are introduced into the combustion vessel 3 to burn the fuel. The heat of combustion is thus transferred to the fuel cell 20 adjacent to the combustion vessel 3, and the temperature of the fuel cell 20 is rapidly raised in order to enable prompt start-up. Dring stationary power generation, only the fuel and water are supplied to the combustion vessel 3, and the fuel and water are heated for vaporization by the heat generated in the fuel cell 20. However, when the energy necessary for vaporization is insufficient, the fuel and water are pre-heated at the combustion vessel 3, introduced into a vaporizer 15 connected via a pipe line, and vaporized in the vaporizer 15. This allows the energy used for vaporization of the fuel and water to be saved, while the energy may also be used for cooling the fuel cell 20. Either the heat of combustion of the combustor 7 or a separately provided heater may be used for vaporization in the vaporizer 15.

### Third Embodiment

FIG. 4 is a diagram of a fuel cell system according to a third embodiment. The structure of the fuel cell system according to the third embodiment that differs from the structure of the fuel cell system according to the first embodiment will be mainly described below.

Since a so-called mid-temperature fuel cell using a polymer electrolyte membrane, represented by a phosphate-doped polybenzimidazole membrane, is able to provide good CO resistance under operation conditions in which the temperature of the fuel cell is high, power generation is possible by directly introducing a reformed gas that contains about 1% of carbon monoxide into the fuel cell.

Consequently, the CO shift converter 5 and CO remover 6 may be omitted as shown in FIG. 4 depending on the performance of the reforming catalyst and fuel. Since the operation temperature of the fuel cell 20 is high in such a fuel cell system, the fuel and water may be reliably vaporized by taking advantage of the heat generated by power generation of the fuel cell 20. Accordingly, the fuel cell system of this embodiment can be miniaturized as compared with the fuel cell system according to the first embodiment. In addition, since the combustion vessel 3 may be utilized as a fuel reactor at the starting of the fuel cell 20 while the combustion vessel 3 may be utilized as a vaporizer during stationary operation of the fuel cell 20, the fuel cell system of this embodiment may have an excellent structure.

The operating temperature of the fuel cell is selected so that no side reaction of the fuel occurs, or the catalyst is selected so that no side reaction of the fuel occurs, in the combustion vessel 3.

### Fourth Embodiment

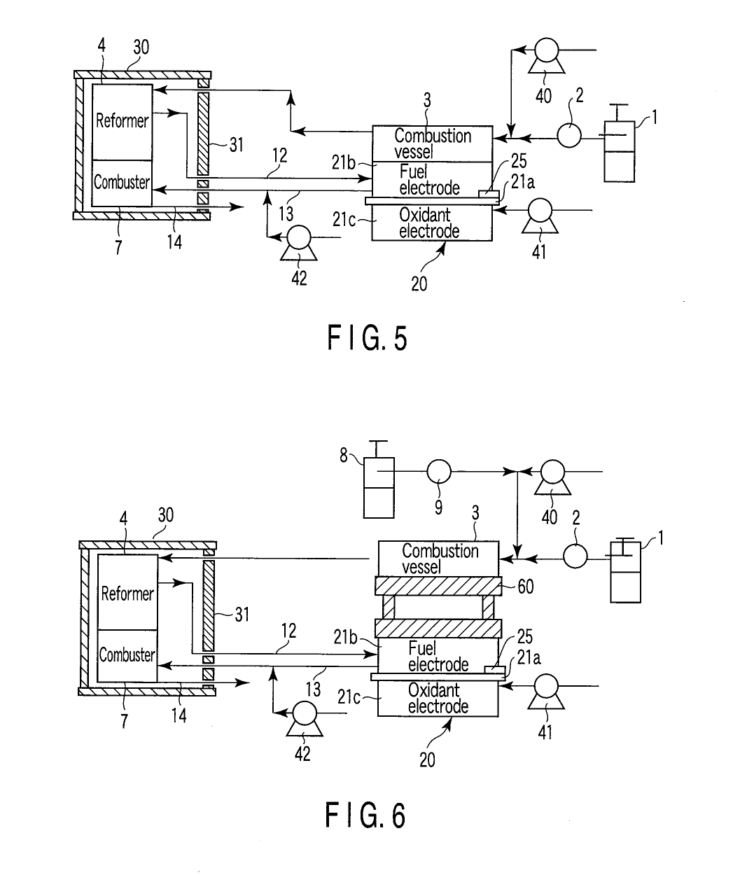

FIG. 5 shows a diagram of a fuel cell system according to a fourth embodiment. The structure of the fuel cell system according to the fourth embodiment that differs from the structure of the fuel cell system according to the third embodiment will be mainly described below.

As shown in FIG. 5, the fuel and water may be contained in a common fuel vessel 1. This configuration enables the water vessel 8 and flow controller 9 to be omitted, and is suitable for miniaturization.

When a mixture of the fuel and water as well as air are supplied, a catalyst that causes combustion reaction at room temperature in the combustion vessel 3 may be used, or a heater heating the combustion vessel 3 up to a reaction-initiating temperature is provided.

### Fifth Embodiment

FIG. 6 shows a diagram of a fuel cell system according to a fifth embodiment. The structure of the fuel cell system according to the fifth embodiment that differs from the structure of the fuel cell system according to the third embodiment will be mainly described below.

As shown in FIG. 6, the combustion vessel 3 is placed apart from the fuel cell 20, and a heat exchanger 60 is provided therebetween. A heat pipe, formed of copper or aluminum, which have good heat conductivity, or a member made of another material having good heat conductivity may be used for the heat exchanger 60. This configuration increases freedom of a positional relation between the fuel cell 20 and combustion vessel 3.

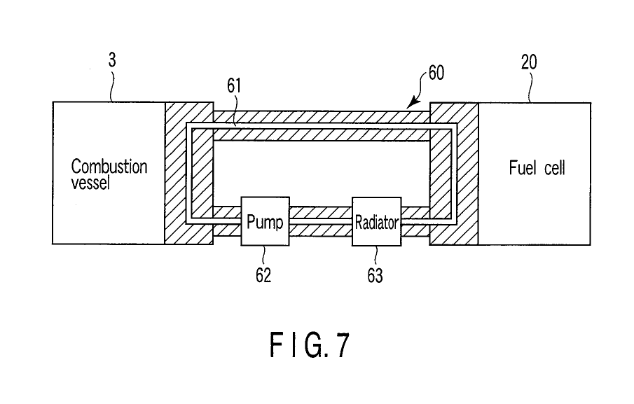

Alternatively, a passage 61 of a heat transfer medium may be formed in the heat exchanger 60 as shown in FIG. 7. A heat transfer medium such as oil or water is circulated in the passage 61 of the heat transfer medium, and the amount of heat transfer may be changed by changing the circulation volume of the heat transfer medium with a pump 62. In this configuration, the fuel cell 20 and combustion vessel 3 may be readily kept at an optimum temperature by keeping heat balance therebetween. When the heat balance among the fuel cell 20, combustion vessel 3 and heat exchanger 60 is positive, a radiator 63 may be provided at the passage 61 of the heat transfer medium for cooling them. Alternatively, a cooling system may be provided at the fuel cell 20 and combustion vessel 3 in place of the radiator 63.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel cell system comprising:
a fuel supplier supplying a hydrocarbon-based fuel;
a water supplier supplying water;
an oxygen supplier supplying an oxygen-containing gas for combustion;
a combustion vessel connected to the fuel supplier, the water supplier and the oxygen supplier, and containing a catalyst to accelerate combustion reaction of the fuel and oxygen;
a reformer connected to the combustion vessel and serving to react the fuel with water to convert them into a hydrogen-containing gas;
a fuel cell disposed to enable heat transfer with the combustion vessel and generating power by electrochemical reaction between the hydrogen-containing gas supplied from the reformer and an oxygen-containing gas for power generation; and
a controller controlling flow rates of the fuel, the water and the oxygen-containing gas for combustion supplied to the combustion vessel by controlling the fuel supplier, the water supplier and the oxygen supplier.

2. The fuel cell system according to claim 1, wherein the controller controls the fuel supplier, the water supplier and the oxygen supplier such that, at starting of the fuel cell system, supplies only the fuel and the oxygen-containing gas for combustion to the combustion vessel.

3. The fuel cell system according to claim 1, wherein the controller controls the fuel supplier, the water supplier and the oxygen supplier such that, during stationary power generation, supplies only the fuel and the water to the combustion vessel.

4. The fuel cell system according to claim 1, wherein the controller controls the fuel supplier, the water supplier and the oxygen supplier such that, during suppression of power generation, supplies the fuel, the water and the oxygen-containing gas for combustion to the combustion vessel so as to leave a part of the fuel by the combustion reaction in the combustion vessel.

5. The fuel cell system according to claim 1, further comprising a temperature detector detecting the temperature of the fuel cell.

6. The fuel cell system according to claim 1, wherein the controller increases an amount of oxygen-containing gas for combustion supplied to the combustion vessel when the temperature of the fuel cell is lowered, and decreases the amount of oxygen-containing gas for combustion supplied to the combustion vessel when the temperature of the fuel cell is raised.

7. The fuel cell system according to claim 1, wherein the combustion vessel vaporizes the fuel and the water.

8. The fuel cell system according to claim 1, wherein the combustion vessel comprises a micro-channel passage.

9. The fuel cell system according to claim 1, further comprising a CO shift converter and a CO remover to reduce CO from the hydrogen-containing gas generated by the reformer.

10. The fuel cell system according to claim 1, further comprising a combustor combusting a waste gas from the fuel cell and heating the reformer.

11. The fuel cell system according to claim 1, further comprising a vaporizer vaporizing the fuel and water pre-heated at the combustion vessel.

12. The fuel cell system according to claim 1, wherein the fuel supplier and the water supplier are integrated.

13. The fuel cell system according to claim 1, wherein a heat exchanger is provided between the combustion vessel and the fuel cell.

14. The fuel cell system according to claim 13, wherein the heat exchanger has a passage of a heat transfer medium and is provided with a pump configured to circulate the heat transfer medium.

15. The fuel cell system according to claim 14, further comprising a radiator configured to cool the heat transfer medium.
